(19) United States
(12) Patent Application Publication
(10) Pub. No.: US 2026/0336584 A1
(43) Pub. Date: Oct. 29, 2026

(54) FAILSAFE BYPASS VALVE ARRANGEMENT AND BRAKING SYSTEM INCLUDING A FAILSAFE BYPASS VALVE ARRANGEMENT

(71) Applicant: ZF CV Systems Global GmbH, Bern (CH)

(72) Inventor: Julian Van Thiel, Grossburgwedel (DE)

(21) Appl. No.: 19/698,721

(22) Filed: Jun. 4, 2026

Related U.S. Application Data
(63) Continuation of application No. PCT/EP2024/083575, filed on Nov. 26, 2024.

(30) Foreign Application Priority Data
Dec. 11, 2023 (DE) 10 2023 134 554.0

(51) Int. Cl. B60T 13/38; B60T 13/26; B60T 15/02

(52) U.S. Cl. CPC B60T 13/385; B60T 13/268; B60T 15/027; B60T 2270/40

(57) ABSTRACT

A failsafe bypass valve arrangement is for a pneumatic parking brake unit of an electronically controllable pneumatic braking system. The failsafe bypass valve arrangement includes: a first path with an electromagnetic monostable valve; a second path with a bistable valve unit; and a relay valve. The first path and the second path receive a primary parking brake pressure of the pneumatic parking brake unit. In a first stable switching position of the bistable valve unit, the primary parking brake pressure is output independently of a switching position of the first monostable valve at a relay valve control port of the relay valve, and in a second stable switching position of the bistable valve unit, the relay valve control port is vented while the first monostable valve is de-energized in order to vent the at least one spring accumulator brake cylinder.

### CROSS-REFERENCE TO RELATED APPLICATIONS

This application is a continuation application of international patent application PCT/EP2024/083575, filed Nov. 26, 2024, designating the United States and claiming priority from German application 10 2023 134 554.0, filed Dec. 11, 2023, and the entire content of both applications is incorporated herein by reference.

### TECHNICAL FIELD

The disclosure relates to a failsafe bypass valve arrangement for a pneumatic parking brake unit of an electronically controllable pneumatic braking system of a vehicle. The disclosure furthermore relates to an electronically controllable pneumatic braking system and a utility vehicle.

### BACKGROUND

For autonomously operated vehicles, in particular automation levels 3 to 5, there is a need to provide a failsafe system that ensures that the vehicle is safely parked in the event of a serious fault. From DE 10 2019 133 010 A1, for example, a system is known which, after an initial release of the parking brake device (that is, filling of the spring accumulator brake cylinders) switches the device back to the park state (that is, venting of the spring accumulator brake cylinders), and then or at the same time fills the spring accumulator brake cylinders via a separately provided monostable release valve, which then, in the event of a fault, falls to a switching position without being energized and thus returns the spring accumulator brake cylinders to a vented state. However, this means that the parking braking system is also switched to a vented state and thus to an applied state while driving, which can lead to plausibility errors in the vehicle. If in such a case the state of the parking brake is queried by another system, an application and thus parked state of the parking brake is reported back, which can lead to a plausibility error when the vehicle is moving.

Other systems that are configured to apply the spring accumulator brake cylinders in the event of a serious fault are also based on similar functions or directly use the parking brake to engage the spring accumulators. A problem that exists when the parking brake itself is used to apply the spring accumulator brake cylinders in the event of a fault is the bistability typically developed in the parking brake. In order to avoid having to permanently energize one or more valves while driving, parking brake modules are typically configured to be bistable, that is, they retain their switching position when de-energized. If, while the vehicle is moving, the parking brake is switched to a driving state in which the spring accumulator brake cylinders are filled, this state is also maintained when the parking brake unit is de-energized. Only if there is a fault in the compressed air supply system and the supply pressure drops would the spring accumulator brake cylinders be applied. A safe parking and braking of the vehicle in a de-energized state typically cannot be achieved in this way.

Other systems that are relevant here are disclosed, for example, in DE 10 2018 108 092 A1, WO 2018/172256 A1, WO 2018/172268 A1, DE 10 2019 106 591 A1, DE 20 2019 106 870 U1 and DE 10 2020 131 688 A1.

### SUMMARY

It is an object of the disclosure, in the event of a fault, to achieve a safe state of the vehicle from a released driving position, that is, an air-filled driving position, of the parking braking system. In particular, such a system should be retrofittable, that is, it can be connected to already existing systems and in particular does not lead to plausibility errors in the vehicle.

The disclosure solves the aforementioned object via a failsafe bypass valve arrangement according to various embodiments of the disclosure. According to an embodiment a failsafe bypass valve arrangement includes a first path with at least one electromagnetic first monostable valve, a second path with a bistable valve unit and a relay valve are provided. According to the disclosure, the first and second paths are configured and configured to be connected via a Y-piece to a parking brake pressure port of the pneumatic parking brake unit in order to receive a primary parking brake pressure of the pneumatic parking brake unit. The first monostable valve and the bistable valve unit are arranged in parallel to each other and connected to a relay valve control port of the relay valve in order to output the primary parking brake pressure, received from the pneumatic parking brake unit, at the relay valve control port, in particular optionally via the first monostable valve and/or the bistable valve unit. The relay valve has a relay valve work port, which is provided to be connected to at least one spring accumulator brake cylinder of the electronically controllable pneumatic braking system in order to output the primary parking brake pressure, received at the relay valve control port, amplified in volume, at the at least one spring accumulator brake cylinder. In this case, it is further provided according to the disclosure that in a first stable switching position of the bistable valve unit, the primary parking brake pressure is output independently of the switching position of the first monostable valve, and in a second stable switching position of the bistable valve unit, the relay valve control port is vented while the first monostable valve is de-energized in order to vent the at least one spring accumulator brake cylinder.

The failsafe bypass valve arrangement proposed here can be integrated into existing systems, namely by connecting the first and second paths via the Y-piece to the parking brake port of an existing pneumatic parking brake unit, which is otherwise connected as usual to the at least one spring accumulator brake cylinder and via which the primary parking brake pressure is provided directly at the at least one spring accumulator brake cylinder. In a preferred embodiment, the parking brake pressure port is the parking brake work port of the parking brake unit. "Primary parking brake pressure" means the pressure output by the parking brake unit, irrespective of whether it is a working pressure which can preferably be provided directly at one or more spring accumulator brake cylinders, or a control pressure which should initially be amplified in volume in order to able to be provided at the one or more spring accumulator brake cylinders. In one embodiment, the parking brake pressure port of the parking brake unit is a port at which a parking brake control pressure is provided. In this embodiment, the primary parking brake pressure is the parking brake control pressure.

The relay valve of the failsafe bypass valve arrangement according to the disclosure is then connected to the relay valve work port at the at least one spring accumulator brake cylinder instead of the parking brake unit, so that the failsafe bypass valve arrangement is installed between or alternatively parallel to the parking brake unit and the at least one spring accumulator brake cylinder. Such a failsafe bypass valve arrangement can, of course, already be provided at the factory, but can also, as described, be particularly advantageously integrated into already existing systems. It is also conceivable that such a failsafe bypass valve arrangement is directly integrated into a parking brake module and can be integrated into the housing of an existing parking brake unit. The pressure applied by the relay valve to at least one spring accumulator brake cylinder is called "secondary parking brake pressure".

In the first stable switching position of the bistable valve unit, the primary parking brake pressure is output independently of the switching position of the first monostable valve, preferably at the relay valve control port, so that in the first stable switching position, the usual operation of the pneumatic parking brake unit is not impaired. Due to the intermediate valves, there is a low latency; however, the primary parking brake pressure output by the parking brake unit is output in equivalent fashion at the at least one spring accumulator brake cylinder, so that, in the event that the pneumatic parking brake unit is in a driving position, the at least one spring accumulator brake cylinder is released, and in the event that that the pneumatic parking brake unit is in a park position, the at least one spring accumulator brake cylinder is vented. In the second stable switching position of the bistable valve unit, the relay valve control port is vented when the first monostable valve is de-energized, and when the first monostable valve is energized, the primary parking brake pressure is preferably output at the relay valve control port. So if the first monostable valve is de-energized, the relay valve control port is vented regardless of the state of the pneumatic parking brake unit, that is, regardless of whether the pneumatic parking brake unit is in a driving position or in a park position, and thus the at least one spring accumulator brake cylinder is also vented and hence applied. In this way, a failsafe function can be implemented via the at least one monostable valve, which leads to the venting of the at least one spring accumulator brake cylinder in the event that a serious fault occurs that leads to the de-energization of the at least one first monostable valve. This function can be activated by switching the bistable valve unit to either the first stable switching position or the second stable switching position. Whereas, in the first stable switching position of the bistable valve unit, the first monostable valve has no influence on the state of at least one spring accumulator brake cylinder, this can be vented via the monostable valve in the second stable switching position of the bistable valve unit. A driver of the vehicle therefore preferably switches the bistable valve unit to the first stable switching position when the driver himself controls the vehicle, and switches the bistable valve unit to the second switching position when the vehicle is driven automatically and therefore such a safety function is advantageous or even necessary.

According to various embodiments, an electromagnetic second monostable valve is provided in the first path, which valve is pneumatically connected in series to the first monostable valve. This can further increase safety if the first and second monostable valves are switched in such a way that it is sufficient for one of the two to be de-energized in order to vent at least one spring accumulator brake cylinder. Therefore, if one of the two valves is defective and does not vent the relay valve control port when de-energized, the second monostable valve is provided for this purpose. This means that the function is configured redundant.

Furthermore, it may be preferred that at least the first monostable valve is de-energized in a venting position. The same applies preferably to the second monostable valve. Both the first and the second monostable valves are preferably configured as monostable 3/2-way valves, wherein they alternately connect a path leading to the relay valve control port to a path coming from the parking brake pressure port or a vent.

According to various embodiments, the failsafe bypass valve arrangement includes a shuttle valve, with a first shuttle valve inlet, a second shuttle valve inlet and a shuttle valve outlet. The shuttle valve is preferably configured as a Select-High valve, which provides the respective higher of the pressures present at the first and second shuttle valve inlet to the shuttle valve outlet. The first shuttle valve inlet is preferably connected to the first path, the second shuttle valve inlet to the second path, and the shuttle valve outlet directly or indirectly to the relay valve control port. As an alternative to such a shuttle valve, a corresponding valve arrangement with pneumatically switchable valves, which performs the same function, may also be provided.

Furthermore, it is preferred that the bistable valve unit has a manually operable 3/2-way valve. Such a manually operable 3/2-way valve may be configured, for example, as a sliding valve. It is preferably located in the driver's cab, so that a vehicle driver can switch between the two modes described above, manual driving and automated mode.

Furthermore, it can be preferred that the bistable valve unit has a pneumatic or electromechanical bistability. A pneumatic bistability may be formed, for example, by a pneumatically self-holding valve or a valve arrangement having a total of three valves, which are interconnected in such a way that a pneumatic bistability is achieved. Such circuits are known to the skilled person. An electromechanical bistability can be achieved in particular by an electromagnetic bistable valve, which preferably has a first and second magnet, in order to provide two magnetic latching positions in this manner. Such electromagnetic bistable valves are also known to the skilled person.

Furthermore, the failsafe bypass valve arrangement can preferably have at least one first pressure sensor for detecting a pressure that can be supplied to the relay valve control port. In this way, a signal can be provided which detects the pressure that is or can be output at the relay valve control port, and can thus provide the relay valve control pressure at an electronic control unit for checking the plausibility and/or for controlling the braking system. According to various embodiments, the failsafe by-pass valve arrangement has a second pressure sensor for detecting a pressure output by the relay valve, so that the pressure output at the at least one spring accumulator brake cylinder can also be detected.

According to various embodiments, the first and/or the second monostable valve are connected to a superordinate control unit, preferably an autonomous driving unit, or a control unit which performs the functions for autonomous driving, and from this receive corresponding switching signals. It may be provided that the switching signals are provided as long as the autonomous driving unit or the corresponding control unit is operational, so that the first or second monostable valve is switched. Only when the autonomous driving unit is de-energized, for example due to a fault, or actively no longer outputs a signal, does the first or second monostable valve fall back into the stable switching positions, preferably under spring loading, so that the relay valve control port is subsequently vented.

In a second aspect, the disclosure solves the problem via an electronically controllable pneumatic braking system according to the disclosure. According to various embodiments, the electronically controllable pneumatic braking system includes a parking brake unit which receives the reservoir pressure from a parking brake compressed air reservoir and is configured to receive an electric or pneumatic parking brake signal and, depending on the parking brake signal, to output a primary parking brake pressure at a parking brake pressure port. It further includes at least one spring accumulator brake cylinder on at least one axle, an autonomous driving unit which is connected to at least one further electronic brake control unit via at least one vehicle bus, and a failsafe bypass valve arrangement, which is preferably configured according to one of the above preferred embodiments of a failsafe bypass valve arrangement according to the first aspect of the disclosure. Both the first path and the second path of the failsafe bypass valve arrangement are connected to the parking brake pressure port of the parking brake unit and from this receive the primary parking brake pressure. The relay valve work port of the bypass valve arrangement is connected to the at least one spring accumulator brake cylinder, and the first monostable valve of the failsafe bypass valve arrangement is connected to the autonomous driving unit and from this receives switching signals.

It should be understood that the failsafe bypass valve arrangement according to the first aspect of the disclosure and the electronically controllable pneumatic braking system according to the second aspect of the disclosure have the same and similar sub-aspects.

According to various embodiments, in the electronically controllable pneumatic braking system, it is provided that the parking brake unit has a parking brake switch which is arranged in a driver's cab. Furthermore, it is preferably provided that the parking brake unit has a manually operable parking brake valve.

According to various embodiments, the first or the second pressure sensor of the bypass valve arrangement is connected to the autonomous driving unit and at this provides a first or second pressure signal respectively.

In a third aspect of the disclosure, the object cited initially is achieved by a utility vehicle according to various embodiments of the disclosure. According to various embodiments, the utility vehicle has a front axle and a rear axle, and an electronically controllable pneumatic braking system according to one of the above-described preferred embodiments of an electronically controllable pneumatic braking system according to the second aspect of the disclosure. It should be understood that the electronically controllable pneumatic braking system according to the second aspect of the disclosure and the utility vehicle according to the third aspect of the disclosure have identical and similar sub-aspects. In this respect, reference is made to the above description in full.

### BRIEF DESCRIPTION OF DRAWINGS

The invention will now be described with reference to the drawings wherein:

FIG. 1 shows an electronically controllable pneumatic braking system with a failsafe bypass valve arrangement in a first embodiment;

FIG. 2 shows the electronically controllable pneumatic braking system according to FIG. 1 with a failsafe bypass valve arrangement in a second embodiment;

FIG. 3 shows another electronically controllable pneumatic braking system having a bypass valve arrangement according to FIG. 1; and,

FIG. 4 shows the electronically controllable pneumatic braking system according to FIG. 1 with a failsafe bypass valve arrangement in a third embodiment.

### DETAILED DESCRIPTION

In the figures, the common elements are described first and then the differences between the different embodiments are explained. In particular, the similarities are not further emphasized and it should be understood that, in principle, each of the embodiments can be combined with the further embodiments.

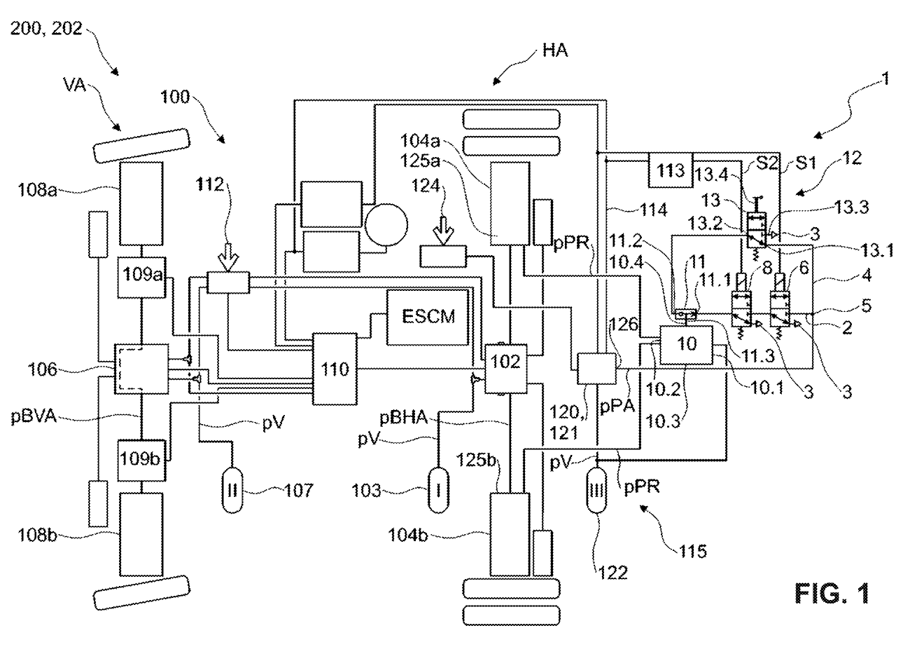

FIG. 1 illustrates an electronically controllable pneumatic braking system 100 for a vehicle 200, in particular a utility vehicle 202. The vehicle 200 has a front axle VA and a rear axle HA, wherein this disclosure also includes vehicles 200 with more than one, namely in particular two, three or more rear axles and also more than one, in particular two, three or four front axles. The electronically controllable pneumatic braking system 100 has a rear axle modulator 102 on the rear axle HA, which receives reservoir pressure pV from a first compressed air reservoir 103 and, depending on a brake request signal, in a known manner outputs a rear axle brake pressure pBHA at first and second rear axle brake actuators 104a, 104b. A front axle modulator 106 is provided in a similar manner on the front axle VA, and receives reservoir pressure pV from a second compressed air reservoir 107 and, in a known manner, outputs a front axle brake pressure pBVA at the first and second front axle brake actuators 108a, 108b. First and second ABS valves 109a, 109b are additionally provided on the front axle VA, in order to implement a blocking protection function.

Both the rear axle modulator 102 and the front axle modulator 106 are connected to a central module 110, which in a known manner provides brake signals both at the rear axle modulator 102 and at the front axle modulator 106, which signals are then converted by the rear axle modulator 102 or front axle modulator 106 and provided to electromagnetic valves in order thus to output the rear axle brake pressure pBHA or front axle brake pressure pBVA. It may also be provided that the central module 110 is directly connected to electromagnetic valves of the rear axle modulator 102 and/or front axle modulator 106, so that they need not have their own intelligence.

The electronically controllable pneumatic braking system 100 is here configured, for example, in such a way that it can be operated both manually by a driver and also automatically. For this purpose, the vehicle 200 firstly has a brake transducer 112 in the form of a brake pedal, which here is connected both to the central module 110, to which it provides brake transducer signals, and also directly to the front axle modulator 106 and the rear axle modulator 102. This is not mandatory; it may be provided that the brake transducer 112 is only connected to the central module 110, only connected pneumatically and/or electrically to the front axle modulator 106 and the rear axle modulator 102, or for example only connected pneumatically to the central module 110 and the front axle modulator 106. The configuration shown here is only an example and the disclosure is explicitly not limited to this.

On the rear axle HA, the electronically controllable pneumatic braking system 100 also has a parking brake circuit 115 and a parking brake unit 120. The parking brake unit 120 is here configured as a parking brake module 121 and thus integrated as a single unit. However, it may also be provided that the parking brake unit 120 is not configured as a parking brake module 121, but can also be realized by separately installed valves in the vehicle 200. The parking brake unit 120 works as known in the prior art and is configured in FIG. 1 as an electropneumatic parking brake unit. It is connected to a parking brake compressed air reservoir 122 (also called third compressed air reservoir) and from this receives reservoir pressure pV. In the embodiment shown in FIG. 1, the parking brake unit 120 is connected firstly to the autonomous driving unit 113 via the vehicle bus 114 and can thus receive a signal from the autonomous driving unit 113 for parking or immobilizing the vehicle 200, and also secondly to a parking brake switch 124, which is typically located in the driver's cab and can be operated manually by a driver. A park position of the truck 200 can also be requested via the parking brake switch 124. For this purpose, the vehicle 200 has on the rear axle HA first and second spring accumulator brake cylinders 125a, 125b, which in a known manner are released when filled and applied when vented. For this purpose, the parking brake unit 120 provides a primary parking brake pressure pPA, which may be a parking brake working pressure, for filling the spring accumulator brake cylinders 125a, 125b.

According to the disclosure, however, the primary parking brake pressure pPA is not provided directly to the first and second spring accumulator brake cylinders 125a, 125b on the rear axle HA, but rather a failsafe bypass valve arrangement 1 is connected between the parking brake unit 120 and the spring accumulator brake cylinders 125a, 125b. In the first embodiment shown in FIG. 1, the failsafe bypass valve arrangement includes a first path 2 and a second path 4, which both receive the primary parking brake pressure pPA and, in the embodiment shown here, are connected to the parking brake pressure port 126 via a Y-piece 5. It is crucial that the first path 2 and the second path 4 receive the same primary parking brake pressure pPA.

The first path 2 has a first electromagnetic monostable valve 6 and a series-connected second electromagnetic monostable valve 8. Both the first and the second monostable valves 6, 8 are de-energized in a venting position in which the first path 2 is connected to a vent 3, while the first and second monostable valves 6, 8 are energized in a passage position in which the primary parking brake pressure pPA can be directed through the first and second monostable valves 6, 8. For this purpose, both the first and the second monostable valves 6, 8 are formed as 3/2-way valves, wherein they are arranged such that the downstream port of the respective 3/2-way valve, viewed from the parking brake unit 120, can be connected alternately to the vent 3 and the port facing the parking brake unit 120.

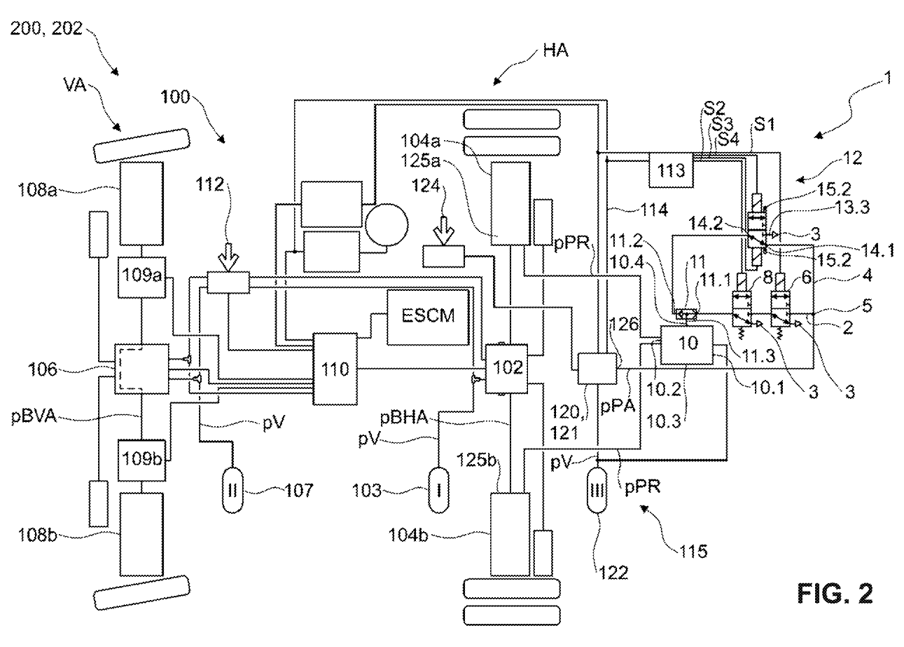

Downstream, the first path 2 is connected to a relay valve 10, which has a relay valve reservoir port 10.1, that is connected to the third compressed air reservoir 122 and receives reservoir pressure pV, a relay valve work port 10.2 (shown in FIG. 2 as two relay valve work ports, where this is purely schematic and both one and two ports may be provided), a relay valve vent port 10.3 and a relay valve control port 10.4. The relay valve work port 10.2 is connected to the first and second spring accumulator brake cylinders 125a, 125b, and the relay valve control port 10.4 is connected to the first or second path 2, 4 such that it can receive the primary parking brake pressure pPA output via the first or second path 2, 4. In the specific embodiment shown in FIG. 1, the relay valve control port 10.4 is firstly connected to a shuttle valve 11, which is preferably configured as a Select-high valve. The shuttle valve 11 has a first shuttle valve inlet 11.1 which is connected to the first path 2, a second shuttle valve inlet 11.2 which is connected to the second path 4, and a shuttle valve outlet 11.3 which is connected to the relay valve 10, preferably to the relay valve control port 10.4. The shuttle valve 11 directs the higher of the pressures applied to the first and second shuttle valve inlets 11.1, 11.2 on to the shuttle valve outlet 11.3.

The first and second monostable valves 6, 8 are electrically connected to the autonomous driving unit 113 and receive from this first and second switching signals S1, S2. In normal operation, the first and second switching signals S1, S2 should be provided so that the first and second monostable valves 6, 8 are in the energized, that is, passage position. In this position, the primary parking brake pressure pPA is controlled via the first path 2, the first and the second monostable valves 6, 8 and the shuttle valve 11 at the relay valve 10, which then provides this amplified in volume as the secondary parking brake pressure pPR at the first and second spring accumulator brake cylinders 125a, 125b, so that these are released. If a serious fault now occurs in the vehicle 200, the first and/or second switching signal S1, S2 also falls away, so that the first path 2 is vented since at least one of the first and second monostable valves 6, 8 falls into the vent position, thus connecting the relay valve control port 10.4 to the vent 3. In this case, the first and second spring accumulator brake cylinders 125a, 125b are also vented and thus applied. In this way, a failsafe function is achieved, which enables safe braking and parking of the truck 200.

For the manual operation of the vehicle 200, it may be advantageous to bypass or deactivate this failsafe function, which is implemented via the first and second monostable valves 6, 8. For this purpose, a bistable valve unit 12 is provided in the second path 4, which has at least one first and second stable switching position, wherein in the first stable switching position (which is shown in FIG. 1), the primary parking brake pressure pPA is provided via the second path 4 at the shuttle valve 11, or more precisely at the second shuttle valve inlet 11.2, and in a second stable switching position (not shown in FIG. 1), the second shuttle valve inlet 11.2 is connected to a vent 3.

Thus, if the first and second monostable valves 6, 8 are energized and in the passage position, the switching position of the bistable valve unit 12 has no influence on the pressure output by the relay valve 10. However, if the bistable valve unit 12 is in the first stable switching position shown in FIG. 1, a passage position, the switching position of the first and second monostable valves 6, 8 has no influence on the pressure output by the relay valve 10, since in any case the primary parking brake pressure pPA is output via the bistable valve unit 12 at the shuttle valve 11 and is thus also provided at the relay valve control port 10.4. Only if the bistable valve unit 12 is switched to the second stable switching position (venting position) not shown in FIG. 1 can the failsafe function can be enabled via the first and second monostable valves 6, 8.

In the embodiment shown in FIG. 1, the bistable valve unit 12 includes a manually operable 3/2-way valve 13, which is shown in FIG. 1 in a passage position and can be moved by actuation of a handle 13.4 into a blocking or venting position. The manually operable 3/2-way valve 13 has a first manual valve port 13.1 connected to the second path 4, namely the part facing the Y-piece 5, and thus receives the primary parking brake pressure pPA output by the parking brake unit 120. The manually operable 3/2-way valve 13 furthermore has a second manual valve port 13.2, which is connected downstream to the second path 4 and leads to the relay valve 10, or more precisely, in the embodiment shown in FIG. 1, to the second shuttle valve inlet 11.2. In addition, the manually operable 3/2-way valve 13 has a third manual valve port 13.3, which is connected to a vent 3. In the passage position, the first manual valve port 13.1 is connected to the second manual valve port 13.2, and in the vent position, the second manual valve port 13.2 is connected to the third manual valve port 13.3. The manually operable 3/2-way valve 13 is preferably arranged in the driver's cab of the vehicle 200, but can also be located somewhere else on the vehicle.

In an advantageous manner, a vehicle driver can move the manually operable 3/2-way valve 13 into the passage position shown in FIG. 1, so that the primary parking brake pressure pPA output by the parking brake unit 120 is always output at the relay valve control port 10.4 via the second path 4 independently of the position of the first and second monostable valves 6, 8. The first and second spring accumulator brake cylinders 125a, 125b are thus filled exactly as the parking brake unit 120 dictates. Even in the event of a failure of the autonomous driving unit 113, the position of the first and second spring accumulator brake cylinders 125a, 125b does not change, provided that the primary parking brake pressure pPA output by the parking brake unit 120 also remains the same. The vehicle 200 behaves in the same way as a normal manually operable vehicle. This switching position should be selected by a driver when driving the vehicle 200. However, if the vehicle 200 is operated in automated or partially automated mode, it is advantageous to move the manually operable 3/2-way valve 13 into the second switching position (not shown in FIG. 1), and thus connect the second shuttle valve inlet 11.2 with the vent 3, since the second manual valve port 13.2 is connected to the third manual valve port 13.3. In this switching position, no pressure is passed on via the second path 4, so that the pressure applied at the relay valve control port 10.4 is always the one which is output via the first path 2. So if the first and second monostable valves 6, 8 are energized, in particular because the autonomous driving unit 113 is functional, and the first and second switching signals S1, S2 are provided, the spring accumulator brake cylinders 125a, 125b are again filled as the parking brake unit 120 dictates. However, if a serious fault occurs that results in the first and/or second switching signal S1, S2 no longer being provided, the first shuttle valve inlet 11.1 is also vented, so that subsequently the relay valve control port 10.4 is also vented, which in turn leads to the venting of the first and second spring accumulator brake cylinders 125a, 125b so that the vehicle stops and is parked.

FIG. 2 now illustrates a second embodiment of the failsafe bypass valve arrangement 1, wherein the same and similar elements are provided with the same reference numerals, so that full reference is made to the above description. The main difference from the first embodiment (FIG. 1) is that instead of the manually operable 3/2-way valve 13, in the second embodiment, the bistable valve unit 12 includes an electromagnetic bistable valve 14. The electromagnetic bistable valve 14 is connected in the same way as has already been described in relation to the manually operable 3/2-way valve 13. The bistable valve 14 has a first bistable valve port 14.1, which is connected to the second path 4 in such a way that it permanently receives the primary parking brake pressure pPA output by the parking brake unit 120. A second bistable valve port 14.2 is connected to the relay valve 10 and to the second shuttle valve inlet 11.2, and a third bistable valve port 14.3 is connected to a vent 3. The bistable valve 14 has, in a known manner, two magnetic latching positions which are realized here as an example by a first magnet 15.1 and a second magnet 15.2, which are controlled separately via third and fourth switching signals S3, S4. The bistable valve 14, like the first and second monostable valves 6, 8, is connected to the autonomous driving unit 113 but can also be connected to a further control unit, in particular, one that performs autonomous driving tasks. The embodiment shown in FIG. 2 is particularly advantageous if, for example, an electric or electronic switch for enabling and disabling autonomous driving mode is provided in the driver's cab of the vehicle 200. For example, in the embodiment shown here, it may then be provided that the autonomous driving unit, when an automated operation is requested, switches the bistable valve 14 to the venting position (not shown in FIG. 2) in order to activate the failsafe function via the first and second monostable valves 6, 8.

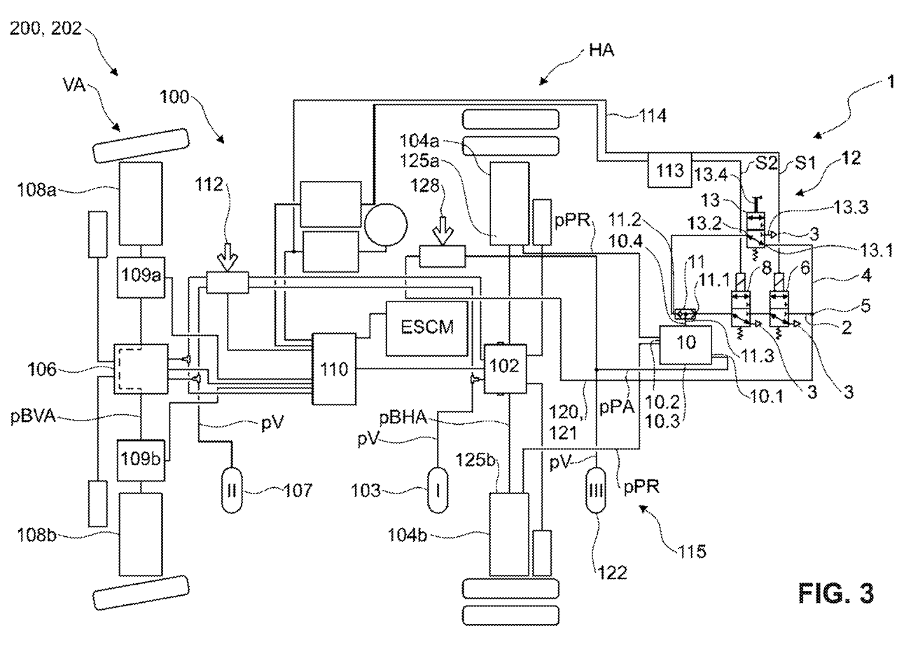

The embodiment shown in FIG. 3 differs from the embodiment shown in FIG. 1 only in the electronically controllable pneumatic braking system 100, namely in that no electropneumatic parking brake unit 120 is provided, but rather a purely pneumatic parking brake valve 128, which in particular can be moved manually into an engagement and release position. In this case, the parking brake valve 128 outputs the primary parking brake pressure pPA, which is then directed to the first and second paths 2, 4 as described above. All other elements are structured in the same way as FIG. 1 and reference is made to the above description.

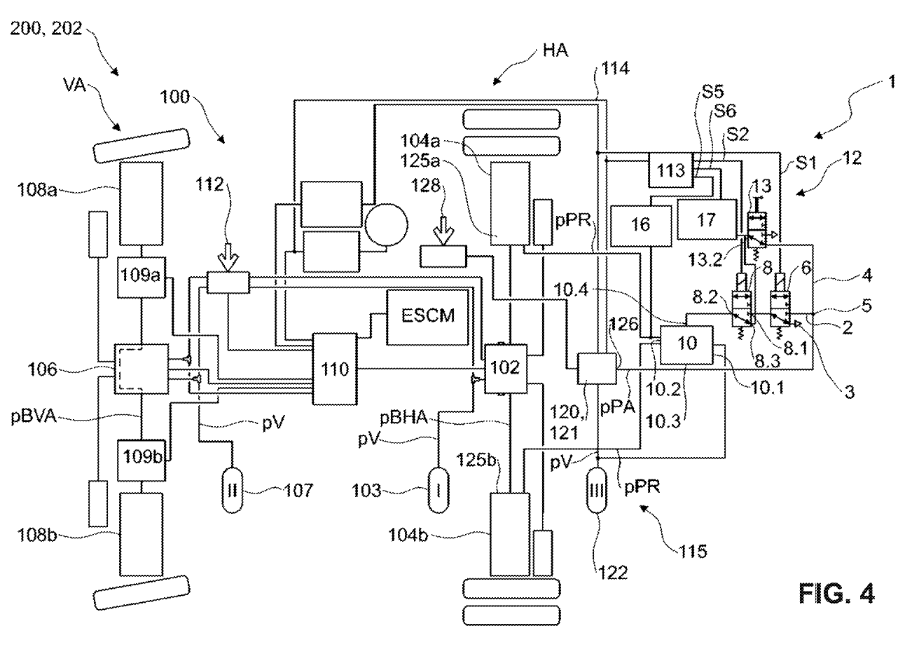

The embodiment shown in FIG. 4 is again based on the embodiment shown in FIG. 1, wherein essentially two differences are to be discussed here.

Firstly, a first pressure sensor 16 and a second pressure sensor 17 are provided, which provide a first pressure signal S5 and second pressure signal S6 respectively, here specifically at the autonomous driving unit 113, wherein the first and second pressure signals S5, S6 could also be provided at other electronic control units. The first pressure sensor 16 measures the secondary parking brake pressure pPR output by the relay valve 10, and in the embodiment shown here, the second pressure sensor 17 measures the pressure output by the manually operable 3/2-way valve 13 and can thus detect the current switching position of the manually operable 3/2-way valve. The second pressure sensor 17 can therefore generally be used to detect the state of the bistable valve unit 12. The first pressure sensor 16, however, detects the state of the spring accumulator brake cylinders. According to various embodiments, a third pressure sensor (not shown here) can detect the pressure output at the parking brake pressure port 126 in order to detect the state of the parking brake unit. Here it should be understood that the first pressure sensor 16 and/or the second pressure sensor 17 can also be provided in the previously described embodiments according to FIGS. 1 to 3.

In addition, the variant according to FIG. 4 does not use the shuttle valve 11. Instead, the bistable valve unit 12 and the first and second monostable valves 6, 8 are connected differently, in order nonetheless to achieve the failsafe function. Specifically, the second manual valve connection 13.2 is not directly connected to the relay valve 10, but to the second monostable valve 8, namely the port of the second monostable valve 8 which in the first embodiment (FIG. 1) is connected to the vent 3. In this respect, in the variant shown in FIG. 4, the first monostable valve 8 can connect either the first path 2 or the second path 4 to the relay valve 10. A first monostable valve port 8.1 is connected to the first monostable valve 6 and from this can receive the primary parking brake pressure pPA. A second monostable valve port 8.2 is connected to the relay valve 10, more precisely to the relay valve control port 10.4, and a third monostable valve port 8.3, which is connected to the vent 3 in FIG. 1, is connected in FIG. 4 to the second manual valve port 13.2. In the switching position shown in FIG. 4, the second monostable valve 8 is de-energized and connects the second manual valve port 13.2 to the second monostable valve port 8.2. In the switching position not shown in FIG. 4, the second monostable valve 8 is energized and connects the first monostable valve port 8.1 to the second monostable valve port 8.2.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Failsafe bypass valve arrangement
2 First path
3 Vent
4 Second path
5 Y-piece
6 First monostable valve
8 Second monostable valve
8.1 First monostable valve port
8.2 Second monostable valve port
8.3 Third monostable valve port
10 Relay valve
10.1 Relay valve reservoir port
10.2 Relay valve work port
10.3 Relay valve vent port
10.4 Relay valve control port
11 Shuttle valve
11.1 First shuttle valve inlet
11.2 Second shuttle valve inlet
11.3 Shuttle valve outlet
12 Bistable valve unit
13 Manually operable 3/2-way valve
13.1 First manual valve port
13.2 Second manual valve port
13.3 Third manual valve port
13.4 Handle
14 Electromagnetic bistable valve
14.1 First bistable valve port
14.2 Second bistable valve port
14.3 Third bistable valve port
15.1 First magnet
15.2 Second magnet
16 First pressure sensor
17 Second pressure sensor
100 Electronically controllable pneumatic braking system
102 Rear axle modulator
103 First compressed air reservoir
104a, 104b Rear axle brake actuators
106 Front axle modulator
107 Second compressed air reservoir
108a, 108b Front axle brake actuators
109A, 109b ABS valves
110 Central module
112 Brake transducer
113 Autonomous driving unit
114 Vehicle bus
115 Parking brake circuit
120 Parking brake unit
121 Parking brake module
122 Third compressed air reservoir / parking brake compressed air reservoir
124 Parking brake switch
125a-125b Spring accumulator brake cylinder
126 Parking brake pressure port
128 Parking brake valve
200 Vehicle
202 Utility vehicle HA Rear axle
pBHA Rear axle brake pressure
pBVA Front axle brake pressure
pPA Primary parking brake pressure
pPR Secondary parking brake pressure
pV Reservoir pressure
S1 First switching signal
S2 Second switching signal
S3 Third switching signal
S4 Fourth switching signal
S5 First pressure signal
S6 Second pressure signal
VA Front axle

1. A failsafe bypass valve arrangement for a pneumatic parking brake unit of an electronically controllable pneumatic braking system of a vehicle, the failsafe bypass valve arrangement comprising:
a first path with at least one electromagnetic first monostable valve;
a second path with a bistable valve unit;
a relay valve;
said first path and said second path being connected via a Y-piece to a parking brake pressure port of the pneumatic parking brake unit in order to receive a primary parking brake pressure of the pneumatic parking brake unit;
said first monostable valve and said bistable valve unit being arranged in parallel and connected to a relay valve control port of said relay valve in order to output the primary parking brake pressure received from the pneumatic parking brake unit at said relay valve control port;
said relay valve having a relay valve work port configured to be connected to at least one spring accumulator brake cylinder of the electronically controllable pneumatic braking system in order to output the primary parking brake pressure, received at the relay valve control port, amplified in volume, at the at least one spring accumulator brake cylinder;
wherein in a first stable switching position of said bistable valve unit, the primary parking brake pressure is output independently of a switching position of said first monostable valve at said relay valve control port, and in a second stable switching position of said bistable valve unit, said relay valve control port is vented while said first monostable valve is de-energized in order to vent the at least one spring accumulator brake cylinder.

2. The failsafe bypass valve arrangement of claim 1 further comprising an electromagnetic second monostable valve in said first path, which is pneumatically connected in series to said first monostable valve.

3. The failsafe bypass valve arrangement of claim 1, wherein said first monostable valve is de-energized in a venting position.

4. The failsafe bypass valve arrangement of claim 1 further comprising:
a shuttle valve having a first shuttle valve inlet, a second shuttle valve inlet, and a shuttle valve outlet;
said first shuttle valve inlet being connected to said first path;
said second shuttle valve inlet being connected to said second path; and,
said shuttle valve outlet being connected to said relay valve control port such that a respective higher one of pressures present at said first shuttle valve inlet and at said second shuttle valve inlet are provided to said shuttle valve outlet.

5. The failsafe bypass valve arrangement of claim 1, wherein said bistable valve unit has a manually operable 3/2-way valve.

6. The failsafe bypass valve arrangement of claim 1, wherein said bistable valve unit has a pneumatic or electromechanical bistability.

7. The failsafe bypass valve arrangement of claim 1, wherein said bistable valve unit has an electromagnetic bistable valve with a first magnet and a second magnet.

8. The failsafe bypass valve arrangement of claim 1 further comprising at least one first pressure sensor for detecting a pressure that is configured to be supplied to said relay valve control port.

9. The failsafe bypass valve arrangement of claim 2, wherein said second monostable valve is a second 3/2-way valve and alternately connects said first monostable valve and said bistable valve unit to said relay valve.

10. The failsafe bypass valve arrangement of claim 1, wherein said first monostable valve is connected to an autonomous driving unit or a control unit which performs the functions for autonomous driving, and is configured to receive a first switching signal from the autonomous driving unit or the control unit.

11. An electronically controllable pneumatic braking system comprising:
a parking brake unit configured to receive a reservoir pressure from a parking brake compressed air reservoir and further configured to receive a parking brake signal and depending on the parking brake signal, to output a primary parking brake pressure at a parking brake pressure port, wherein the parking brake signal is an electric parking brake signal or a pneumatic parking brake signal;
at least one spring accumulator brake cylinder on at least one axle;
an autonomous driving unit connected to at least one further electronic brake control unit via a vehicle bus;
a failsafe bypass valve arrangement including a first path with at least one electromagnetic first monostable valve, a second path with a bistable valve unit, and a relay valve;
said first path and said second path being connected via a Y-piece to said parking brake pressure port of said parking brake unit in order to receive the primary parking brake pressure of said parking brake unit;
said first monostable valve and said bistable valve unit being arranged in parallel and connected to a relay valve control port of said relay valve in order to output the primary parking brake pressure received from said parking brake unit at said relay valve control port;
said relay valve having a relay valve work port connected to said at least one spring accumulator brake cylinder in order to output the primary parking brake pressure, received at the relay valve control port, amplified in volume, at said at least one spring accumulator brake cylinder;
wherein in a first stable switching position of said bistable valve unit, the primary parking brake pressure is output independently of a switching position of said first monostable valve at said relay valve control port, and in a second stable switching position of said bistable valve unit, said relay valve control port is vented while said first monostable valve is de-energized in order to vent said at least one spring accumulator brake cylinder; and,
said first monostable valve being connected to said autonomous driving unit and being configured to receive switching signals from said autonomous driving unit.

12. The electronically controllable pneumatic braking system of claim 11, wherein said parking brake unit has a parking brake switch which is arranged in a driver's cab.

13. The electronically controllable pneumatic braking system of claim 11, wherein said parking brake unit has a manually operable parking brake valve.

14. The electronically controllable pneumatic braking system of claim 11, wherein said failsafe bypass valve arrangement further includes at least one first pressure sensor for detecting a pressure that is configured to be supplied to said relay valve control port; and,
said first pressure sensor is connected to said autonomous driving unit and is configured to provide a first pressure signal at said autonomous driving unit.

15. A utility vehicle comprising:
a front axle;
a rear axle;
an electronically controllable pneumatic braking system having a parking brake unit, at least one spring accumulator brake cylinder, an autonomous driving unit, and a failsafe bypass valve arrangement;
said parking brake unit being configured to receive a reservoir pressure from a parking brake compressed air reservoir and being further configured to receive a parking brake signal and depending on the parking brake signal, to output a primary parking brake pressure at a parking brake pressure port, wherein the parking brake signal is an electric parking brake signal or a pneumatic parking brake signal;
said at least one spring accumulator brake cylinder being on provided on at least one of said front axle and said rear axle;
said autonomous driving unit being connected to at least one further electronic brake control unit via a vehicle bus;
said failsafe bypass valve arrangement including a first path with at least one electromagnetic first monostable valve, a second path with a bistable valve unit, and a relay valve;
said first path and said second path being connected via a Y-piece to said parking brake pressure port of said parking brake unit in order to receive the primary parking brake pressure of said parking brake unit;
said first monostable valve and said bistable valve unit being arranged in parallel and connected to a relay valve control port of said relay valve in order to output the primary parking brake pressure received from said parking brake unit at said relay valve control port;
said relay valve having a relay valve work port connected to said at least one spring accumulator brake cylinder in order to output the primary parking brake pressure, received at the relay valve control port, amplified in volume, at said at least one spring accumulator brake cylinder;
wherein in a first stable switching position of said bistable valve unit, the primary parking brake pressure is output independently of a switching position of said first monostable valve at said relay valve control port, and in a second stable switching position of said bistable valve unit, said relay valve control port is vented while said first monostable valve is de-energized in order to vent said at least one spring accumulator brake cylinder; and,
said first monostable valve being connected to said autonomous driving unit and being configured to receive switching signals from said autonomous driving unit.
